(19) United States
(12) Patent Application Publication
(10) Pub. No.: US 2026/0221160 A1
(43) Pub. Date: Jul. 30, 2026

(54) VIDEO TRANSITIONS

(71) Applicant: Nokia Technologies Oy, Espoo (FI)

(72) Inventor: Marc Van Den Broeck, Sint-Katelijne-Waver (BE)

(21) Appl. No.: 19/202,096

(22) Filed: May 8, 2025

(30) Foreign Application Priority Data
May 10, 2024 (GB) 2406573.2

(51) Int. Cl. G11B 27/031; H04N 5/91

(52) U.S. Cl. CPC G11B 27/031; H04N 5/91

(57) ABSTRACT

According to various, but not necessarily all, examples an apparatus includes circuitry for: causing recording of a first scene over a first time period using a limited field of view as a first video; causing recording of the first scene using an expanded field of view at least at a one terminal portion of the first time period; producing a composite video including the first video, an independently recorded second video, and a transition between the first and second videos; and automatically generating the transition, wherein the transition includes a sequence of video frames representing a sequence of different views of the first scene within the expanded field of view, wherein the video frames representing different views of the first scene are generated from the recording made of the first scene using the expanded field of view.

### TECHNOLOGICAL FIELD

Examples of the disclosure relate to transitions between videos included in a composite video.

### BACKGROUND

It is known to use camera movement, or more generally viewpoint dynamics, to link shots across a transition in composite videos. Unless a user has planned for these transitions before capturing the shots, however, the user either has to cut their shots to where there is suitable movement, leading to loss of content, or must apply effects via video editing software such as wipe effects and blur to create a poor simulation of real-life motion.

### BRIEF SUMMARY

According to various, but not necessarily all, examples there is provided an apparatus comprising means for: causing recording of a first scene over a first time period using a limited field of view as a first video; causing recording of the first scene using an expanded field of view at least at one terminal portion of the first time period; producing a composite video comprising the first video, an independently recorded second video, and a transition between the first and second videos; and automatically generating the transition, wherein the transition comprises a sequence of video frames representing a sequence of different views of the first scene, wherein the video frames representing different views of the first scene are generated from the recording made of the first scene using the expanded field of view.

In some but not necessarily all examples, the means are configured to automatically generate the transition based on selection of the first and second videos as adjacent content for the composite video.

In some but not necessarily all examples, the means are configured to generate the sequence of different views of the first scene in dependence on a pre-existing characteristic of the second video.

In some but not necessarily all examples, the means are configured to determine the pre-existing characteristic of the second video by at least one of: analysis of the second video; or reading metadata stored for the second video.

In some but not necessarily all examples, the means are configured to generate the sequence of different views of the first scene to match one or more changes, during a terminal portion of the second video, in one or more of: point of view; or field of view.

In some but not necessarily all examples, the means are configured to generate the sequence of different views of the first scene to centralise an object in the first scene which matches an object in the second video.

In some but not necessarily all examples, the different views of the first scene differ in terms of one or more of: point of view; or field of view.

In some but not necessarily all examples, the different views of the first scene correspond to points of view along a trajectory defined with respect to the first scene.

In some but not necessarily all examples, the sequence of different views of the first scene simulates panning.

In some but not necessarily all examples, the sequence of different views of the first scene within the expanded field of view simulates a zoom.

In some but not necessarily all examples, the second video is of a second scene over a second time period, wherein at least one of the following is true: the second scene is different to the first scene; or the second time period is different to the first time period.

In some but not necessarily all examples, the means are configured to: cause recording of the second scene over the second time period using the limited field of view as the second video; cause recording of the second scene using the expanded field of view at least at a terminal portion of the second time period.

In some but not necessarily all examples, the transition further comprises a sequence of video frames representing a sequence of different views of the second scene, wherein the video frames representing different views of the second scene are generated from the recording made of the second scene using the expanded field of view.

In some but not necessarily all examples, the terminal portion of the first time period is a beginning portion of the first time period or an ending portion of the first time period.

In some but not necessarily all examples, the means are configured to cause recording of the first scene using the expanded field of view at two terminal portions of the first time period, the two terminal portions corresponding respectively to a beginning and an end of the first time period.

In some but not necessarily all examples, the means are configured to cause recording of the first scene using only the limited field of view for a portion of the first time period.

In some but not necessarily all examples, the means are configured to cause recording of a single image of the first scene using an expanded field of view at least at one terminal portion of the first time period.

In some but not necessarily all examples, the means are configured to cause recording of a sequence of images of the first scene using an expanded field of view at least during one terminal portion of the first time period.

In some but not necessarily all examples, the means are configured to store the first video in a first data structure, different to a second data structure in which the second video is stored.

In some but not necessarily all examples, the means are configured to: construct a virtual visual space in dependence on the recording of the first scene using the expanded field of view; control a virtual camera within the virtual visual space to record the sequence of video frames representing different views of the first scene within the expanded field of view.

In some but not necessarily all examples, the means are configured to: cause range imaging of the first scene to obtain depth data; construct a depth map of the first scene from the depth data; construct the virtual visual space from the depth map by texturing the depth map with the recording of the first scene using the expanded field of view.

In some but not necessarily all examples, the apparatus further comprises means for capturing image data within the limited field of view and means for capturing image data within the expanded field of view.

In some but not necessarily all examples, the means for capturing image data within the expanded field of view comprise multiple means for capturing overlapping narrower fields of view from different points of view, wherein the expanded field of view is defined by the multiple overlapping narrower fields of view from the different points of view.

According to various, but not necessarily all, examples there is provided a method comprising: causing recording of a first scene over a first time period using a limited field of view as a first video; causing recording of the first scene using an expanded field of view at least at a terminal portion of the first time period; producing a composite video comprising the first video, an independently recorded second video, and a transition between the first and second videos; and automatically generating the transition, wherein the transition comprises a sequence of video frames representing a sequence of different views of the first scene, wherein the video frames representing different views of the first scene are generated from the recording made of the first scene using the expanded field of view.

According to various, but not necessarily all, examples there is provided a: computer program; computer product; non-transitory computer readable medium; or machine readable medium, comprising instructions stored thereon for performing at least the following: causing recording of a first scene over a first time period using a limited field of view as a first video; causing recording of the first scene using an expanded field of view at least at a terminal portion of the first time period; producing a composite video comprising the first video, an independently recorded second video, and a transition between the first and second videos; and automatically generating the transition, wherein the transition comprises a sequence of video frames representing a sequence of different views of the first scene, wherein the video frames representing different views of the first scene are generated from the recording made of the first scene using the expanded field of view.

According to various, but not necessarily all, embodiments there is provided an apparatus comprising: at least one processor; and at least one memory including computer program code, the at least one memory storing instructions that, when executed by the at least one processor, cause the apparatus to perform at least a part of one or more methods described herein.

According to various, but not necessarily all, embodiments there is provided an apparatus comprising means for performing at least part of one or more methods described herein. The description of a function and/or action should additionally be considered to also disclose any means suitable for performing that function and/or action. Functions and/or actions described herein can be performed in any suitable way using any suitable method.

According to various, but not necessarily all, embodiments there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function.

### BRIEF DESCRIPTION

Some examples will now be described with reference to the accompanying drawings in which:

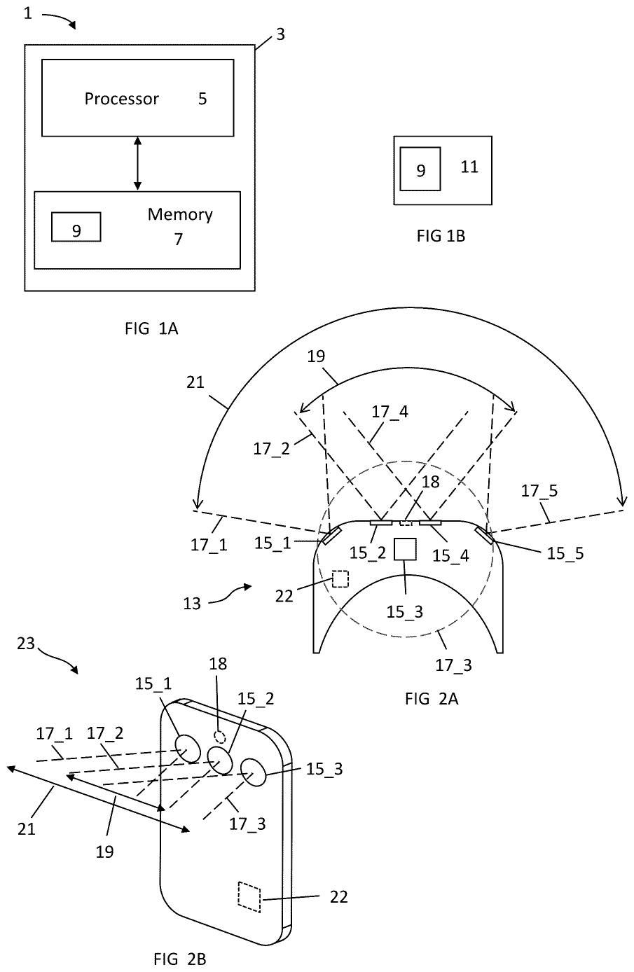

FIGS. 1A and 1B show an example of the subject matter described herein;

FIGS. 2A and 2B show another example of the subject matter described herein;

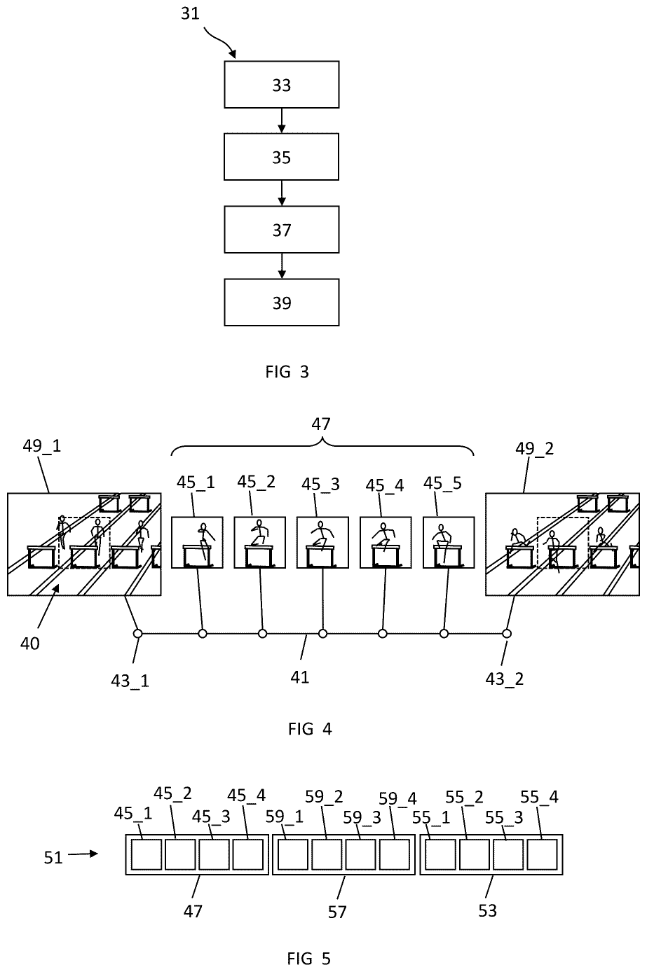

FIG. 3 shows another example of the subject matter described herein;

FIG. 4 shows another example of the subject matter described herein;

FIG. 5 shows another example of the subject matter described herein;

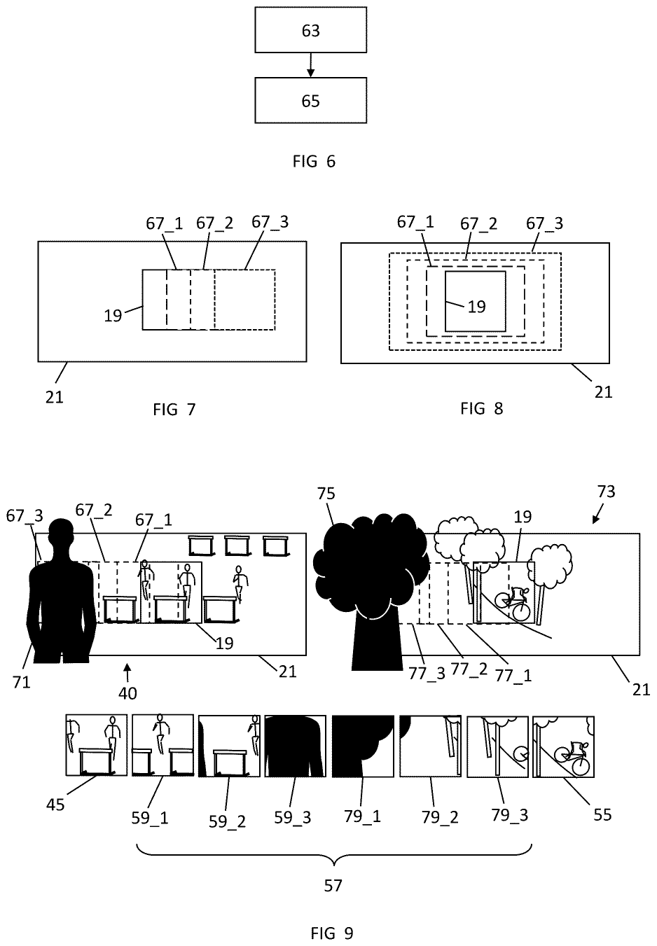

FIG. 6 shows another example of the subject matter described herein;

FIG. 7 shows another example of the subject matter described herein;

FIG. 8 shows another example of the subject matter described herein;

FIG. 9 shows another example of the subject matter described herein;

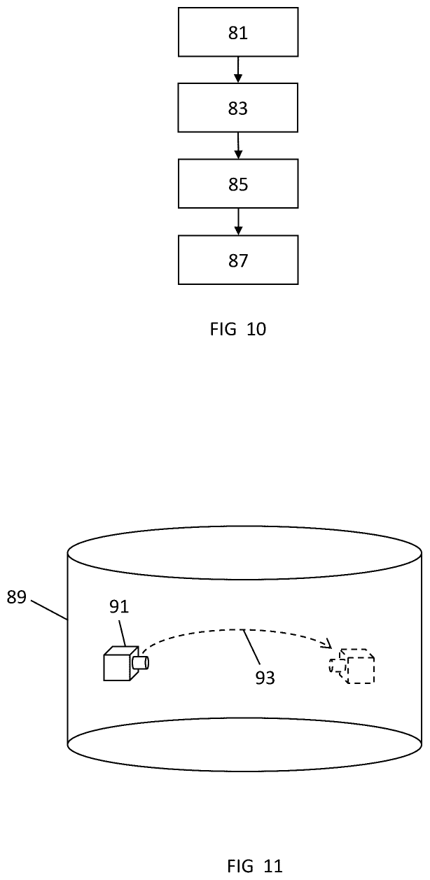

FIG. 10 shows another example of the subject matter described herein; and

FIG. 11 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 10) and a specific instance of the class (member of the set) can be referenced using the reference number with a numerical type subscript index (e.g. 10_1) and a non-specific instance of the class (member of the set) can be referenced using the reference number with a variable type subscript index (e.g. 10_i).

### DETAILED DESCRIPTION

The FIGs illustrate a method and means for: causing recording of a first scene 40 over a first time period 41 using a limited field of view 19 as a first video 47; causing recording of the first scene 40 using an expanded field of view 21 at least at one terminal portion 43 of the first time period 41; producing a composite video 51 comprising the first video 47, an independently recorded second video 53, and a transition 57 between the first and second videos 47, 53; and automatically generating the transition 57, wherein the transition 57 comprises a sequence of video frames 59 representing a sequence of different views 67 of the first scene 40, wherein the video frames 59 representing different views 67 of the first scene 40 are generated from the recording 49 made of the first scene 40 using the expanded field of view 21.

By automatic generating a sequence of different views 67 within an expanded field of view 21, which was recorded at a terminal portion 43, for example a beginning or end, of the recording period 41 of a limited field of view video 47 of a first scene 40, to serve as the transition 57 between different videos 47, 53 in a composite video 31, a need for the user to consider recording footage for such transitions at the time-of-recording the videos 47, 53 is removed.

FIG. 1A illustrates an example of a controller 3 suitable for use in an apparatus 1. Implementation of a controller 3 may be as controller circuitry. The controller 3 may be implemented in hardware alone, have certain aspects in software including firmware alone or can be a combination of hardware and software (including firmware).

As illustrated in FIG. 1A the controller 3 may be implemented using instructions that enable hardware functionality, for example, by using executable instructions 9 in a general-purpose or special-purpose processor 5 that may be stored on a machine readable storage medium (disk, memory etc.) to be executed by such a processor 5.

The processor 5 is configured to read from and write to the memory 7. The processor 5 may also comprise an output interface via which data and/or commands are output by the processor 5 and an input interface via which data and/or commands are input to the processor 5.

The memory 7 stores instructions, program, or code 9 that controls the operation of the apparatus 1 when loaded into the processor 5. The computer program instructions, program or code am 9, provide the logic and routines that enables the apparatus 1 to perform the methods illustrated in the accompanying FIGs. The processor 5 by reading the memory 7 is configured to load and execute the instructions, program, or code 9.

The apparatus 1 comprises:
at least one processor 5; and
at least one memory 7 storing instructions that, when executed by the at least one processor 5, cause the apparatus at least to:
   record a first scene 40 over a first time period 41 using a limited field of view 19 as a first video 47;
   record the first scene 40 using an expanded field of view 21 at least at a terminal portion 43 of the first time period 41;
   produce a composite video 51 comprising the first video 47, an independently recorded second video 53, and a transition 57 between the first and second videos 47, 53; and
   automatically generating the transition 57,
wherein the transition 57 comprises a sequence of video frames 59 representing a sequence of different views 67 of the first scene 40, wherein the video frames 59 representing different views 67 of the first scene 40 are generated from the recording 49 made of the first scene 40 using the expanded field of view 21.

As illustrated in FIG. 1B, the instructions, program, or code 9 may arrive at the apparatus 1 via any suitable delivery mechanism 11. The delivery mechanism 11 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 9. The delivery mechanism may be a signal configured to reliably transfer the computer program 9. The apparatus 1 may propagate or transmit the computer program 9 as a computer data signal.

The term “non-transitory” as used herein, is a limitation of the medium itself (i.e., tangible, not a signal) as opposed to a limitation on data storage persistency (e.g., RAM vs. ROM).

Computer program instructions for causing an apparatus to perform at least the following or for performing at least the following:
causing recording of a first scene 40 over a first time period 41 using a limited field of view 19 as a first video 47; causing recording of the first scene 40 using an expanded field of view 21 at least at a terminal portion 43 of the first time period 41; producing a composite video 51 comprising the first video 47, an independently recorded second video 53, and a transition 57 between the first and second videos 47, 53; and automatically generating the transition 57, wherein the transition 57 comprises a sequence of video frames 59 representing a sequence of different views 67 of the first scene 40, wherein the video frames 59 representing different views 67 of the first scene 40 are generated from the recording 49 made of the first scene 40 using the expanded field of view 21.

The computer program instructions may be comprised in a computer program, a non-transitory computer readable medium, a computer program product, a machine readable medium. In some but not necessarily all examples, the computer program instructions may be distributed over more than one computer program.

Although the memory 7 is illustrated as a single component/circuitry it may be implemented as one or more separate components/circuitry some or all of which may be integrated/removable and/or may provide permanent/semi-permanent/dynamic/cached storage.

Although the processor 5 is illustrated as a single component/circuitry it may be implemented as one or more separate components/circuitry some or all of which may be integrated/removable. The processor 5 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all the following:
(a) hardware-only circuitry implementations (such as implementations in only analog and/or digital circuitry) and
(b) combinations of hardware circuits and software, such as (as applicable):
   i. a combination of analog and/or digital hardware circuit(s) with software/firmware and
   ii. any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the claim element, a baseband integrated circuit for a mobile device or a similar integrated circuit in a server, a cellular network device, or other computing or network device.

The blocks illustrated in the accompanying FIGS may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The apparatus 1 may be the controller 3 or a device comprising the controller 3. The device may be a headset 13, an example of which is illustrated in FIG. 2A, or a handset 23, an example of which is illustrated in FIG. 2B, or any other device having suitable means for capturing image data within a limited field of view 19 and suitable means for capturing image data within an expanded field of view 21. The means for capturing the image data, whether within the limited field of view 19 or within the expanded field of view 21, can be one or more image sensors 15. The means for capturing image data within the expanded field of view may comprise multiple means for capturing overlapping narrower fields of view from different points of view, wherein the expanded field of view is defined by the multiple overlapping narrower fields of view from the different points of view. The multiple means for capturing overlapping narrower fields of view from different points of view can be multiple image sensors 15.

FIG. 2A illustrates a headset 13 comprising a plurality of image sensors 15 having different points of view (position and/or orientation relative to a scene). The fields of view 17 of the different image sensors 15 overlap. In this example, a limited field of view 19 may be defined by overlapping fields of view 17_2, 17_4 of two forward facing image sensors 15_2, 15_4. An expanded field of view 21 may be defined by, additionally, fields of view 17_1, 17_5, 17_3 of two sideward facing images sensors 15_1, 15_5 and a field of view 17_3 of an upwards facing image sensor 15_3. The narrow fields of view 17 from each of the image sensors 15 overlap to define the expanded field of view 23.

FIG. 2A illustrates a handset 23 comprising a plurality of image sensors 15 having different points of view (position and/or orientation relative to a scene). The fields of view 17 of the different image sensors 15 overlap. In this example, a limited field of view 19 may be defined a field of view 17_2 of a single image sensor 15_2 in the centre of an arrangement of the image sensors 17. An expanded field of view 21 may be defined by additionally, fields of view 17_1, 17_3 of images sensors 15_1, 15_3 to either side of the central image sensor 15_2. The narrow fields of view 17 from each of the image sensors 15 overlap to define the expanded field of view 23.

In some but not necessarily all examples, the headset 13, handset 23, or any other device comprising the means for capturing image data within the limited field of view 19 and means for capturing image data within the expanded field of view 21, comprise ranging means 18 for performing range imaging of the scene to obtain depth data. The ranging means 18 may comprise, without limitation, a LIDAR sensor, a structure-light three-dimensional scanner, or a time-of-flight camera.

In some but not necessarily all examples, the headset 13, handset 23, or any other device comprising the means for capturing image data within the limited field of view 19 and means for capturing image data within the expanded field of view 21, comprise one or more motion sensors 22, such as for example gyroscopes, accelerometer, and/or magnetometers, to track movement and/or tilt of the device during recording of the scene. The motion sensors may be configured to detect changes in three degrees of three-dimensional orientation and/or three degrees of three-dimensional orientation.

Although in the illustrated examples of FIGS. 2A and 2B the expanded field of view 21 is captured by additional image sensors to the central one or more image sensors responsible for capturing the limited field of view 19, it will be appreciated that one image sensor may capture both the limited field of view 19 and the expanded field of view 21, with the difference of field of view resulting from controlling the spatial extent of pixel readout from that one image sensor.

FIG. 3 illustrates a method 31 of producing a composite video. In some but not necessarily all examples, the method 31 is be a computer-implemented method, for example implementable by the controller 3. The method 31 comprises control of the means for capturing image data within a limited field of view 19 and means for capturing image data within an expanded field of view 21, for example one or more image sensors 15. The method 31 further comprises video processing.

In the following description of FIG. 3, reference is made to a number of elements, examples of which are first illustrated in FIG. 4, such as a first scene 40, a first time period 41, terminal portions 43 of the first time period 41, a first video 47, frames 45 of the first video 47, and the recording 49 made of the first scene 40 using the expanded field of view 21. Reference is also made to a number of elements, examples of which are first illustrated in FIG. 5, such as a composite video 51, a transition 57, frames 59 of the transition 57, a second video 53, and frames 55 of the second video 53.

The method 31 comprises, at block 33, causing recording of a first scene 40 over a first time period 41 using a limited field of view 19. The limited field of view 19 of the first scene 40 over the first time period 41 is recorded as a first video 47.

A scene refers to perceivable information, including visual information, from a physical environment. The perceivable information pertains to the environment and objects and activities therein. Recording a scene produces a storable representation of the physical environment and objects and activities therein.

A limited field of view 19 refers to a field of view which is less than the full, available field of view 17 for recording a scene, given the means for capturing image data which are available.

The first video 47 is a single, continuous sequence of frames 45 recorded of the first scene 40 over the first time period 41. This sequence has beginning and end points coinciding with the first time period 41. In the parlance of filmmaking or video production, the first video 47 may be referred to as a “shot” or, more casually, as a “clip”.

In some but not necessarily all examples, the recording of the first scene 40 over the first time period 41 using the limited field of view 19 is user-directed. The user supervises or controls the recording. The user chooses when the recording begins and when to end it and chooses the point of view from which to record the first scene 40 and any changes thereto during the recording.

To cause recording of the first scene 40 over the first time period 41 using the limited field of view 19, the controller 3 may output a control signal to one or more images sensors 15 which have a (collective) field of view 17 which defines the limited field of view 19.

The first video 47 is stored in a first data structure. The first video 47 may be stored as an encapsulated set of video frames 45 along with, in some examples, associated metadata.

The method 31 comprises, at block 35, causing recording of the first scene 40 using an expanded field of view 21 at least at a terminal portion 43 of the first time period 41.

Recording the first scene 40 using an expanded field of view 21 means that a greater spatial extent of the first scene 40 is recorded at a given instant than if the first scene 40 were to be recorded using only the limited field of view 19. In some but not necessarily all examples, the expanded field of view 21 is the full, available field of view 17 for recording the first scene 40.

The recording 49 made of the first scene 40 using the expanded field of view 21 comprises image data, for example a single image or a sequence of images such as frames of a video. In the subsequent disclosure, the term “image data 49” may be used as a stand-in for the recording 49, though this should not be understood to exclude other data, such as audio data, being recorded alongside image data.

The terminal portion of a time period can refer to a time at either extremity of the time period, that is: at the beginning or at the end. This may be, in the case of the beginning, a time immediately preceding the time period and/or the first part of the time period. This may be, in the case of the end, a time immediately following the time period and/or the last part of the time period. In some examples, the terminal portion may correspond to a single set of pixel readouts. In other examples, the terminal portion may span multiple set of pixel readouts. In some examples, the terminal portion may last for 1-2 seconds, during which time, multiple frames with the expanded field of view 21 are recorded.

In some but not necessarily all examples, the method 31 comprises causing recording of the first scene using an expanded field of view 21 at both terminal portions 43 of the first time period 41, that is: at both the beginning 43_1 and the end 43_2 of the first time period 41. This provides visual information for generation of both a transition into the first video 47 and a transition out of the first video 47.

In some but not necessarily all examples, there may be no or limited recording of the first scene 40 using an expanded field of view 21 during the first time period 41. For example, the method 31 may comprise causing recording of the first scene 40 using only the limited field of view 19 for a portion of the first time period 41.

As an example of this, recording of the first scene 40 using an expanded field of view 21 may be triggered in response to a user activating a live viewfinder image for a potential recording of the first scene 40 using the limited field of view 19. The image data 49 of the first scene recorded using the expanded field of view 21 may be temporarily recorded, for example in a buffer. That image data 49 may be deleted after a specified interval. Once recording of the first scene 40 using the limited field of view 19 is initiated, for example under the user's control, the current contents of the buffer are stored as a pre-recording of the first scene 40. Once recording of the first scene 40 using the limited field of view 19 is initiated, recording of the first scene 40 using an expanded field of view 21 may be ceased. The cessation of the recording of the first scene 40 using the limited field of view 19 as the first video 47, for example under the user's control, may trigger another recording of the first scene 40 using an expanded field of view 21. This recording may last for a specified interval and all image data 49 recorded may be stored as a post-recording of the first scene 40.

In other but not necessarily all other examples, there may be recording, but no or limited storing of image data 49 of the first scene 40 recorded using an expanded field of view 21 during the first time period 41. For example, the method 31 may comprise storing from among all recordings of the first scene 40 during at least one portion of the first time period 41 outside of terminal portions 43 of the first time period 41, only those recordings of the first scene 40 made using the limited field of view 19.

As an illustrative example of this, initiation of the recording of the first scene 40 using the limited field of view 19 as the first video 47, for example under the user's control, may trigger recording of the first scene 40 using an expanded field of view 21. Image data of the first scene 40 recorded using an expanded field of view 21 during an initial specified interval may be stored. Subsequently, during the recording of the first video 47, image data 49 of the first scene 40 recorded using an expanded field of view 21 may be temporarily recorded, for example in a buffer. That image data 49 may be deleted after a specified interval. The cessation of the recording of the first scene 40 using the limited field of view 19 as the first video 47, for example under the user's control, may trigger the current contents of the buffer to be stored and recording of the first scene 40 using an expanded field of view 21 to cease.

The recordings of the first scene 40 using an expanded field of view 21 which are to be stored, be that a single image or a sequence of images at one or both of the terminal portions, may be included in the first data structure along with the first video 47 or may be stored in a separate, but associated data structure.

FIG. 4 provides an illustrative example of blocks 33 and 35 of the method 31.

In the example of FIG. 4, the first scene 40 is of a running track environment in which a hurdle race is being run. The first video 47 comprises a sequence of frames 45 recorded of the first scene 40 over the first time period 41. An illustrative, though not necessarily complete selection of the frames 45 are depicted. The limited field of view 19 is directed at a single runner over the first time period 41. In this example, image data 49 of the first scene 40 is recorded using an expanded field of view 21 at both terminal portions 43 of the first time period 41. The image data 49_1 at the beginning 43_1 of the first time period 41 represents three runners approaching respective hurdles. The image data 49_2 at the end 43_2 of the first time period 41 represents three athletes either clearing or having cleared their respective hurdles. A greater section, both in terms of length and number of lanes, of the running track is represented in the image data 49 of the first scene 40 recorded using the expanded field of view 21 than is represented in the first video 47. This enables the generation of transitions into or out of the first video 47 which involve views of other athletes or sections of the running track.

Returning to FIG. 3, it will be appreciated that blocks 33 and 35 of the method 31 can be repeated multiple times in respect of further scenes and/or further time periods.

In some but not necessarily all examples, the method 31 comprises: causing recording of the second scene over a second time period using the limited field of view 19 as a second video 53; and causing recording of the second scene using the expanded field of view 21 at least at a terminal portion of the second time period.

The first video 47 is stored in a first data structure and the second video 53 is stored in a second, different data structure. The different data structures could be, for example: separate files on a file system; separate records in a database; separate content objects within a content management system. Storing the first and second videos 47, 53 in different data structures enables independent storage, retrieval and management of the first and second videos 47, 53. The first and second videos 47, 53 are different encapsulated sets of video frames 45, 55. Each is a self-contained unit with its own set of video frames 45, 55 and associated metadata.

The method 31 comprises, at block 37, producing a composite video 51 comprising the first video 47, an independently recorded second video 53, and a transition 57 between the first and second videos 47, 53.

An example of at least part of a composite video 51 is illustrated in FIG. 5. In this example, the first video 47, comprising a first sequence of frames 45, precedes the second video 53, comprising a second sequence of frames 55, in a timeline of the composite video 51. The transition 57 is a transition out of the first video 57 and into the second video 53.

The second video 53 may be recorded by the same apparatus 1 as recorded the first video 47 or may be recorded by another device. Regardless, the second video 53 is recorded independently of the first video 47. The first and second videos 47, 53 are recorded by two discrete acts of recording. The act of recording the second video 53 is not triggered by the act of recording the first video 47. Likewise, the act of recording the first video 47 is not triggered by the act of recording the second video 53. There is no intrinsic causal relationship between the act of recording the first video 47 and the act of recording the second video 53. That is, there is no intrinsic causal relationship between the actions performed by the apparatus 1 to record the first video 47 and the actions performed by the apparatus 1 (or another device) to record the second video 53. This should be understood in contrast to any extrinsic causal relationship between the two acts of recording which may or may not exist in the mind of the user or users directing the recording of the two videos 47, 53. The second video is 53 is not produced from the recordings 49 made of the first scene 40 using the expanded field of view 21 at least at one terminal portion 43 of the first time period 41. Likewise, the first video is 47 is not produced from any recordings made of the second scene using the expanded field of view 21 at least at one terminal portion of the time period over which the second video 53 is recorded. In some examples, the first and second videos 47, 53 are not derived from different spatial and/or temporal portions of a single, continuous act of recording using one or more image sensors 15 of the same apparatus 1.

In some but not necessarily all examples, the second video 53 is of a second scene over a second time period, wherein at least one of the following is true: the second scene is different to the first scene; or the second time period is different to the first time period. The first video 47 may have been recorded in a different physical environment to the second video 53 and the time-of-recording of the first and second videos 47, 53 may be the same or different. Alternatively, the first and second videos 47, 53 may have been recorded in the same physical environment at different times.

The method 31 comprises, at block 39, automatically generating the transition 57, wherein the transition 57 comprises a sequence of video frames 59 (as shown in FIG. 5) representing a sequence of different views of the first scene 40.

The video frames 59 representing different views of the first scene 40 within the expanded field of view 21 are generated from the recording 49 made of the first scene 40 using the expanded field of view 21 in block 35.

In some but not necessarily all example, the different views of the first scene 40 which are represented in the transition 57 differ from a view captured or capturable using the limited field of view 19. These different views may differ from a view captured using the limited field of view 19 in terms of one or more of: point of view; or field of view.

In some but not necessarily all examples, the transition 57 is automatically generated based on selection, for example user selection, of the first and second videos 47, 53 as adjacent content for the composite video 51. User selection of the first and second videos 47, 53 as adjacent content for the composite video 51 may be by placement or arrangement of the first and second videos 47, 53 as adjacent clips in a timeline interface of video editing software. The automatically generated transition 57 may be presented to the user as an option or recommendation for the composite video 51 and the user may accept it or request that an alternative transition is generated.

Where a scene depicted in the second video 53, for example the aforementioned second scene, has additionally been recorded using an expanded field of view and that additional image data is retrievable for the production of the composite video 51, in some but not necessarily all examples, the transition 57 can further comprise a sequence of video frames representing a sequence of different views of the second scene, wherein the video frames representing different views of the second scene are generated from the recording made of the second scene using the expanded field of view. In some but not necessarily all examples, this may be contingent on: the second scene having been recorded with the expanded field of view at the beginning of the second time period over which the second video 53 is recorded, if the second video 53 follows the first video 47 in the timeline of the composite video 51; or the second scene having been recorded with the expanded field of view at the end of the second time period over which the second video 53 is recorded, if the second video 53 precedes the first video 47 in the timeline of the composite video 51.

In some but not necessarily all examples, the sequence of video frames 59 representing the sequence of different views of the first scene 40 can be intermixed with the sequence of video frames representing the sequence of different views of the second scene. Where these two sequences are of equal duration, their frames may be interleaved within the transition 57.

The transition 57 does not represent a continuous pan across the space separating the first scene 40 from a scene depicted in the second video 53 and the duration of the transition 57 is independent of time elapsed between the recording of the first video 47 and the recording of the second video 53.

In some but not necessarily all examples, the sequence of different views of the first scene 40 is generated in dependence on a pre-existing characteristic of the second video 53. FIG. 6 illustrates relevant blocks in the method 31 for generating the sequence of different views of the first scene 40 in dependence on a pre-existing characteristic of the second video 53.

At block 63, the method 31 comprises determining a pre-existing characteristic of the second video 53 by: analysis of the second video 53; or reading metadata stored for the second video 53.

At block 65, the method 31 comprises generating, for the transition 57, the sequence of different views of the first scene 40 in dependence on the determined pre-existing characteristic of the second video 53.

In some but not necessarily all examples, the pre-existing characteristic of the second video 53 relates to movement, for example a change in point of view or field of view during the second video 53. In some but not necessarily all examples, block 65 comprises generating the sequence of different views of the first scene 40 to match one or more changes, during the second video 53, in one or more of: point of view; or field of view. In some examples, the one or more changes to be matched may be changes during a terminal portion of the second video 53. If the transition 57 will be used to transition into the second video 53, the one or more changes to be matched may be changes at a beginning of the second video 53. If the transition 57 will be used to transition out of the second video 53, the one or more changes to be matched may be changes at an end of the second video 53.

In some but not necessarily all examples, the different views of the first scene 40, which are represented in a sequence of video frames 59 comprised in the transition 57, differ in terms of one or more of: point of view; or field of view. They may differ in terms of one or more of: point of view; or field of view so as to match one or more changes, during a terminal portion of the second video, in one or more of: point of view; or field of view.

For example, as illustrated in FIG. 7, the different views 67 of the first scene 40 can correspond to points of view along a trajectory defined with respect to the first scene 40. The trajectory may match a trajectory of point of view in the second video 53. The sequence of different views 67 of the first scene 40 can simulate panning. The direction and/or speed of panning may be chosen to match the direction and/or speed of a panning movement in the second video 53.

In other examples, as illustrated in FIG. 8, the sequence of different views 67 of the first scene 40 simulates a zoom, such as a digital zoom, through graduated or incremental changes in field of view. The direction and/or speed of zoom may be chosen to match the direction and/or speed of zoom in the second video 53.

Where the recording of the second video 53 is part of the method 31, the method 31 may further comprise storing, as metadata of the second video 53, parameters indicative of change, during recording of the second video 53, in one or more of: point of view; or field of view. Motion sensors 22 may be used to determine these parameters.

The method 31 may comprise storing, as metadata of the first video 47, parameters indicative of change, during recording of the first video 47, in one or more of: point of view; or field of view to enable similar generation of a sequence of video frames representing a sequence of different views of the second scene for inclusion in the transition 57. The sequence of video frames representing a sequence of different views of the second scene may be automatically generated to match one or more changes, during the first video 47, for example during a terminal portion of the first video 47, in one or more of: point of view; or field of view.

As an alternative to matching a change in point of view or field of view during the second video 53, block 65 can, in some other, but not necessarily all other, examples comprise generating the sequence of different views 67 of the first scene 40 to avoid conflicting with one or more changes during a terminal portion of the second video 53, in one or more of: point of view; or field of view. For example, the transition 57 into the second video 53 may not be generated to simulate a leftwards panning movement if the second video 53 begins with a rightward pan or, in some examples, any other pan which is not directed leftwards.

In another alternative, the movement characteristic may be associated with an object represented in the second video 53, rather than with point of view or field of view during the second video 53.

In some but not necessarily all examples, the pre-existing characteristic of the second video 53 relates to the presence of an object in the second video 53. In some but not necessarily all examples, block 65 comprises generating the sequence of different views 67 of the first scene 40 to bring to increased prominence, for example by centralizing, an object in the first scene 40 which matches an object in the second video 53 or in the second scene, where in addition to the second video 53 an expanded field of view of the second scene is recorded. The object in the first scene may be the same object or type of object as is present in the second video 53 or second scene. The object in the first scene may share one or more characteristics with an object which is present in the second video 53 or second scene, such as both comprising large, dark objects for example.

The method 31 may comprise image or video processing, including object recognition, in order to identify objects and their locations in the recordings of the first and second scenes. This may be performed at or proximate the time of recording and stored as metadata of the recordings or at the time of producing the composite video 51.

In some but not necessarily all examples, the sequence of different views 67 of the first scene 40 can simulate panning, where the target of the panning is an object in the first scene 40 which has been determined to match an object in the second video 53 or second scene. The target object may be selected as one which is in the expanded field of view 21, but outside of the limited field of view 19, of the first scene 40 or at least one which is not in the centre of the limited field of view 19 of the first scene 40. An example is illustrated in FIG. 9.

FIG. 9 illustrates an example in which there are two large, dark objects 71, 75 within the first and second scenes 40, 73 respectively. In the first scene 40, the object 71 is a spectator of a hurdles event who is in the near foreground. The spectator 71 is outside the limited field of view 19 with which the first video 47 is recorded but is within the expanded field of view 21 and is thus recorded at least at a terminal portion 43, for example end 43_2, of the first time period 41 of recording. The spectator 71 is to the left of the portion of the first scene 40 within the limited field of view 19. In the second scene 73, the object 75 is a tree which is in the near foreground. The tree 75 is outside the limited field of view 19 with which the second video 53 is recorded but is within the expanded field of view 21 and is thus recorded at least at a terminal portion, for example beginning, of the second time period of recording. The tree 75 is to the left of the portion of the second scene 73 within the limited field of view 19. The transition 57 comprises a sequence of video frames 59 representing a sequence of different views 67 of the first scene 40 which simulate panning leftwards until the view is obscured by the spectator 71. The transition 57 further comprises a sequence of video frames 79 representing a sequence of different views 77 of the second scene 73 which simulate panning rightwards, out from behind the tree 75, which obscures a view of the second scene 73, back to the portion of the second scene 73 which is within the limited field of view 19. Accordingly, the first and second videos 47, 53 are connected by a transition 57 which simulates moving a camera away from action in the first scene 40, behind an obstacle, blocking the camera view to dark, and then moving the camera out from behind an obstacle, towards action in the second scene 73.

In some but not necessarily all examples, the sequence of different views 67 of the first scene 40 can simulate a zoom, such as a digital zoom, where the target of the zoom is an object 71 in the first scene 40 which has been determined to match an object 75 in the second video 53 or second scene 73. The target object 71 may be selected as one in the expanded field of view 21, but outside of the limited field of view 19, of the first scene 40 or at least one which is not in the centre of the limited field of view 19 of the first scene 40.

The pan or zoom, for which the object 71 in the first scene 40 is a target, may end with the target object 71 in a corresponding position within the video frame as the matching object 75 appears in the first frame of the second video 53.

In the foregoing, reference has been made to objects 71, 75 within the first and second scenes 40, 73. However, the foregoing teaching applies equally to virtual objects overlayed onto recordings of the scenes 40, 73.

In such examples, the method 31 can comprise overlaying a virtual object onto a region of the first scene 40 recorded using the expanded field of view 21 and determining the sequence of different views 67 of the first scene 40 to simulate a pan or a zoom to the virtual object. The virtual object may be selected to match an object 75 in the second video 53 or second scene 73. The virtual object may be a reproduction of an object 75 in the second video 53 or second scene 73. The virtual object may match one or more characteristics of an object 75 in the second video 53 or second scene 73.

In some but not necessarily all examples, the video frames 59 representing different views 67 of the first scene 40, which are included in the transition 57, are selected from image data 49 captured by different image sensors 15 which in combination capture the expanded field of view 21. Additional video frames 59, representing intermediate views of the first scene 40 with respect to the views captured by the different image sensors 15, are optionally generated by interpolation between the captured image data 49 and included in the sequence of video frames 59 forming the transition 57. Varying degrees of blur may be applied to the image data used as the video frames 59 to simulate motion blur, and optionally easing-in and easing-out of the motion.

In some but not necessarily all examples, the video frames 59 representing different views 67 of the first scene 40, which are included in the transition 57, are generated by differently cropping image data 49 representing the expanded field of view 21 of the first scene 40, whether that image data 49 is captured by a single, wide-angle image sensor or is the result of stitching. Varying degrees of blur may be applied to the image data used as the video frames 59 to simulate motion blur, and optionally easing-in and easing-out of the motion.

In some but not necessarily all examples, the sequence of video frames 59 is generated from a virtual visual space 89, an example of which is illustrated in FIG. 11, which is constructed in dependence on the recording of the first scene 40 using the expanded field of view 21. FIG. 10 illustrates relevant blocks in the method 31 for constructing a virtual visual space 89 and using it for generating the sequence of video frames 59.

At block 81, range imaging of the first scene 40 is caused in order to obtain depth data concerning the first scene 40. The range imaging may be performed by ranging means 18, for example a LIDAR sensor. In some but not necessarily all examples, the range imaging is caused to be performed contemporaneously with the recording of the first scene 40 using the expanded field of view 21.

At block 83, a depth map of the first scene 40 is constructed from the depth data.

At block 85, the virtual visual space 89 is constructed from the depth map by texturing the depth map with the recording 49 made of the first scene 40 using the expanded field of view 21.

In some but not necessarily all examples, rather than performing blocks 81 and 83, the virtual visual space 89 is constructed by projecting the recording 49 made of the first scene 40 using the expanded field of view 21 onto an inner surface of at least part of a sphere or cylinder of constant radius.

At block 87, a virtual camera 91 within the virtual visual space 89 is controlled to record the sequence of video frames 59 representing different views 67 of the first scene 40. The virtual camera 91 records a representation of the virtual visual space 89 viewed from its point of view (position) within the virtual visual space 89. To record the different views 67, the virtual camera 91 may be moved along a trajectory 93 within the virtual visual space 89. The point of view of the virtual camera 91 may have six degrees of freedom (three degrees of three-dimensional orientation and three degrees of three-dimensional orientation).

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The recording of data may comprise only temporary recording, or it may comprise permanent recording or it may comprise both temporary recording and permanent recording, Temporary recording implies the recording of data temporarily. This may, for example, occur during sensing or image capture, occur at a dynamic memory, occur at a buffer such as a circular buffer, a register, a cache or similar. Permanent recording implies that the data is in the form of an addressable data structure that is retrievable from an addressable memory space and can therefore be stored and retrieved until deleted or over-written, although long-term storage may or may not occur. The use of the term ‘capture’ in relation to an image relates to temporary recording of the data of the image. The use of the term ‘store’ in relation to an image relates to permanent recording of the data of the image.

The apparatus 1 can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to ‘comprising only one . . . ’ or by using ‘consisting.’

In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “ determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following:” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

I/We claim:

1. An apparatus, comprising :
at least one processor; and
at least one memory storing instructions that, when executed with the at least one processor, cause the apparatus to perform:
causing recording of a first scene over a first time period using a limited field of view as a first video;
causing recording of the first scene using an expanded field of view at least at one terminal portion of the first time period;
producing a composite video comprising the first video, an independently recorded second video, and a transition between the first and second videos; and
automatically generating the transition, wherein the transition comprises a sequence of video frames representing a sequence of different views of the first scene, wherein the video frames representing different views of the first scene are generated from the recording made of the first scene using the expanded field of view.

2. The apparatus of claim 1, wherein the instructions, when executed with the at least one processor, cause the apparatus to automatically generate the transition based on selection of the first and second videos as adjacent content for the composite video.

3. The apparatus of claim 1, wherein the instructions, when executed with the at least one processor, cause the apparatus to generate the sequence of different views of the first scene in dependence on a pre-existing characteristic of the second video.

4. The apparatus of claim 3, wherein the instructions, when executed with the at least one processor, cause the apparatus to determine the pre-existing characteristic of the second video with at least one of:
analysis of the second video; or
reading metadata stored for the second video.

5. The apparatus of claim 1, wherein the instructions, when executed with the at least one processor, cause the apparatus to generate the sequence of different views of the first scene to match one or more changes, during a terminal portion of the second video, in one or more of: point of view; or field of view.

6. The apparatus of claim 1, wherein the instructions, when executed with the at least one processor, cause the apparatus to generate the sequence of different views of the first scene to centralise an object in the first scene which matches an object in the second video.

7. The apparatus of claim 1, wherein the different views of the first scene differ in terms of one or more of: point of view; or field of view.

8. The apparatus of claim 1, wherein the different views of the first scene correspond to points of view along a trajectory defined with respect to the first scene.

9. The apparatus of claim 1, wherein the sequence of different views of the first scene simulates panning.

10. The apparatus of claim 1, wherein the sequence of different views of the first scene within the expanded field of view simulates a zoom.

11. The apparatus of claim 1, wherein the second video is of a second scene over a second time period, wherein at least one of the following is true:
the second scene is different to the first scene; or
the second time period is different to the first time period.

12. The apparatus of claim 11, wherein the instructions, when executed with the at least one processor, cause the apparatus to:
cause recording of the second scene over the second time period using the limited field of view as the second video; and
cause recording of the second scene using the expanded field of view at least at a terminal portion of the second time period.

13. The apparatus of claim 12, wherein the transition further comprises a sequence of video frames representing a sequence of different views of the second scene, wherein the video frames representing different views of the second scene are generated from the recording made of the second scene using the expanded field of view.

14. The apparatus of claim 1, wherein the terminal portion of the first time period is a beginning portion of the first time period or an ending portion of the first time period.

15. The apparatus of claim 1, wherein the instructions, when executed with the at least one processor, cause the apparatus to cause recording of the first scene using the expanded field of view at two terminal portions of the first time period, the two terminal portions corresponding respectively to a beginning and an end of the first time period.

16. The apparatus of claim 1, wherein the instructions, when executed with the at least one processor, cause the apparatus to cause recording of the first scene using the limited field of view for a portion of the first time period.

17. The apparatus of claim 1, wherein the instructions, when executed with the at least one processor, cause the apparatus to cause recording of a single image of the first scene using an expanded field of view at least at one terminal portion of the first time period.

18. The apparatus of claim 1, wherein the instructions, when executed with the at least one processor, cause the apparatus to cause recording of a sequence of images of the first scene using an expanded field of view at least during one terminal portion of the first time period.

19. The apparatus of claim 1, wherein the instructions, when executed with the at least one processor, cause the apparatus to store the first video in a first data structure, different to a second data structure in which the second video is stored.

20. The apparatus of claim 1, wherein the configured instructions, when executed with the at least one processor, cause the apparatus to:
construct a virtual visual space in dependence on the recording of the first scene using the expanded field of view; and
control a virtual camera within the virtual visual space to record the sequence of video frames representing different views of the first scene within the expanded field of view.

21. The apparatus of claim 20, wherein the instructions, when executed with the at least one processor, cause the apparatus to:
cause range imaging of the first scene to obtain depth data;
construct a depth map of the first scene from the depth data; and
construct the virtual visual space from the depth map with texturing the depth map with the recording of the first scene using the expanded field of view.

22. The apparatus of claim 1, wherein the instructions, when executed with the at least one processor, cause the apparatus to perform capturing image data within the limited field of view and capturing image data within the expanded field of view.

23. The apparatus of claim 22, wherein the instructions, when executed with the at least one processor, cause the apparatus to perform capturing overlapping narrower fields of view from different points of view, wherein the expanded field of view is defined with the multiple overlapping narrower fields of view from the different points of view.

24. A method, comprising:
causing recording of a first scene over a first time period using a limited field of view as a first video;
causing recording of the first scene using an expanded field of view at least at a terminal portion of the first time period;
producing a composite video comprising the first video, an independently recorded second video, and a transition between the first and second videos; and
automatically generating the transition, wherein the transition comprises a sequence of video frames representing a sequence of different views of the first scene, wherein the video frames representing different views of the first scene are generated from the recording made of the first scene using the expanded field of view.

25. A non-transitory program storage device readable with an apparatus, tangibly embodying a program of instructions executable with the apparatus for performing at least the following:
causing recording of a first scene over a first time period using a limited field of view as a first video;
causing recording of the first scene using an expanded field of view at least at a terminal portion of the first time period;
producing a composite video comprising the first video, an independently recorded second video, and a transition between the first and second videos; and
automatically generating the transition, wherein the transition comprises a sequence of video frames representing a sequence of different views of the first scene, wherein the video frames representing different views of the first scene are generated from the recording made of the first scene using the expanded field of view.
